(19) United States
(12) Patent Application Publication
(10) Pub. No.: US 2005/0016592 A1
(43) Pub. Date: Jan. 27, 2005

(54) Process control valve

(76) Inventors: Peter James Jeromson, Auckland (NZ); James Raymond Bilyard, Auckland (NZ)

Correspondence Address: BROOKS KUSHMAN P.C., 1000 TOWN CENTER, TWENTY-SECOND FLOOR, SOUTHFIELD, MI, 48075, US

(21) Appl. No.: 10/495,522

(22) PCT Filed: Nov. 12, 2002
(86) PCT No.: PCT/NZ02/00249

(30) Foreign Application Priority Data
Nov. 13, 2001 (NZ) 515434

(51) Int. Cl. G05D 7/06

(52) U.S. Cl. 137/487.5

(57) ABSTRACT

A “plug and play” process control valve 10 providing closed loop feedback control has a built in microprocessor 40, stepper-motor 20, a position encoder, a valve body having an inlet 11 and an outlet 12, and pressure sensors 30, 31 positioned within the inlet 11 and the outlet 12 of the valve body, the pressure sensors being connected to the microprocessor 20, which is in turn connected to an input from the position encoder, and provided with outputs to the step-per-motor 40. Within the valve body there are a pair of apertured ceramic shear action discs 13, 14. The stepper-motor rotates the upper disc 14 relative to the apertured stator disc 13 to control pressure or flow in the pipeline.

### FIELD OF THE INVENTION

This invention relates to process control valves where it is desirable to control the pressure or flow rate of a fluid within a pipeline.

### BACKGROUND OF THE INVENTION

Traditional flow control valves have made use of globe valves coupled to a pneumatic or hydraulic controller to control the opening or closing of the valve dependent upon measurements made at different positions along the pipeline. Such measurements use, for example, pressure sensors, the output of which is connected to a central controller, which monitors the fluid parameters at a particular section of the pipeline, and sends control signals to the appropriate actuator to adjust the opening or closing of one or more valves. Such systems are complex, and require special installation, and in some cases may suffer from a time lag between the sensing of the process perameter, and the action taken to adjust the pressure or flow rate of the fluid.

### OBJECT OF THE INVENTION

It is an object of this invention to provide an improved process valve, or one which would at least provide the public with a useful choice.

### STATEMENT OF INVENTION

In one aspect the invention provides a valve having a valve body, the body having at least one inlet, for connection to a fluid pipeline, and at least one outlet for connection to a fluid pipeline, wherein flow through the valve is controlled by rotatable valve means having at least one aperture there through, so that the relative rotational position of the rotatable valve means enables the fluid to flow through the valve to be controlled by opening or closing the aperture of the rotatable valve means, the rotatable valve means being controlled by an actuator, and at least one sensor mounted within the valve body to monitor a desired parameter within the valve body, and means for controlling the actuator in response to signals from the sensor.

For example, the at least one sensor may be a flow sensor or one or more pressure sensors, or may salinity, conductivity, or temperature.

It is preferred that the actuator is an electric motor and it is particularly preferred that the actuator is an electrical stepper motor.

Preferably the valve body has a first pressure sensor associated with a fluid inlet area, and a second pressure sensor associated with the fluid outlet area.

More preferably each of these pressure sensors is positioned within a non-turbulent portion of the valve.

By utilising two pressure sensors within the valve itself, it is also possible to calculate the flow rate of the fluid through the valve.

In a particularly preferred aspect the invention provides a valve having a valve body, the body having at least one inlet, for connection to a fluid pipeline, and at least one outlet for connection to a fluid pipeline, wherein flow through the valve is controlled by a pair of rotatable discs, rotatable relative to one another, each disc having at least one aperture there through, so that the relative rotational position of one disc with respect to the other enables the fluid to flow through the valve to be controlled by opening or closing the relative aperture created by the alignment of the apertures in the two discs, the relative motion of the discs being controlled by an actuator, and at least one pressure sensor mounted within the valve body to monitor the pressure within the valve body, and means for controlling the actuator in response to signals from the pressure sensor.

It is preferred that the rotatable discs are shear action discs.

Preferably the valve body has a first pressure sensor associated with a fluid inlet area, and a second pressure sensor associated with the fluid outlet area.

More preferably each of these pressure sensors is positioned within a non-turbulent portion of the valve.

By utilising two pressure sensors within the valve itself, it is possible to calculate the flow rate of the fluid through the valve.

It is preferred that the actuator is an electric motor and it is particularly preferred that the actuator is an electrical stepper motor.

It is preferred that the rotatable discs, are low friction, ceramic discs, with one disc being mounted in a stationary position, and the other disc rotatable relative to the stationary disc by the action of the electric stepper motor. Alternatively the rotatable discs could be low friction plastic discs, tungsten on steel, or any other suitable material. The material and its properties may be varied depending on the fluid characteristics.

It is particularly preferred that the valve of this invention is provided as a complete subsystem containing the valve, stepper motor, pressure sensors, and microprocessor controller, such that the microprocessor controller is connected to the pressure sensors, and is programmed to control the action of the stepper motor, and hence the relative position of the shear action discs. This enables the complete subsystem to be installed in a pipeline as a “plug and play” component. The subsystem may have its own battery power supply, although it is preferred that it is connected to a mains power supply, so that the only connections needed are the connection between the valve and the inlet and outlet pipes, connection to a mains power supply, and optionally a connection between the microprocessor controller and a data bus connected to a main process computer. Although the valve of this invention can be operated on its own to control flow or pressure to specific manually chosen levels, it also preferable that the unit can be controlled by a central controller, so that the pressure or flow rate at any given point can be controlled by the central computer.

In another aspect the invention provides a process control valve for installation in a pipeline, the valve having a valve body, the body having at least one fluid inlet port and at least one fluid outlet port; a first disc member capable of defining at least one inlet aperture communicating with said at least one inlet port; and a second disc member capable of defining at least one outlet aperture communicating with said at least one outlet port; the first and second disc members are arranged in sealing contact and are rotatable relative to one another; an electric motor capable of rotating at least one of the discs relative to the other disc; means for determining the relative rotational position of the discs; at least one sensor mounted within the valve body to monitor a desired parameter within the valve body; a microprocessor controller capable of controlling the operation of the motor and hence the relative position of the discs; and wherein the at least one pressure sensor is connected to the microprocessor controller, the at least one inlet aperture is substantially sector shaped and the at least one outlet aperture is substantially sector shaped so that relative rotation of the discs by the electric motor provides control over the desired parameter within the pipeline, and also allows for the fluid flow to be completely impeded when the apertures are not aligned with one another.

Preferably the disc members are ceramic discs. Although other materials may be used, e.g. steel discs or in some applications plastic discs.

Preferably the motor is a stepper motor.

Preferably the valve body has a first pressure sensor mounted in the fluid inlet part, and a second pressure sensor mounted in the fluid outlet part.

Optionally the sensor can be a flow sensor mounted within the valve (suitable flow sensors can measure (a) the cooling rate of liquid passing a heated item, or (b) movement of a paddle wheel, propeller or the like).

Preferably the means for determining the relative rotational position of the discs includes an encoder having an output connected to the microprocessor controller.

Preferably the microprocessor is connected to a user controlled input capable of selecting a chosen output parameter.

Preferably the valve body has one fluid inlet port and one fluid outlet port; and the first disc member has two sector-shaped inlet apertures; and a second disc member having two sector-shaped lobes capable of fully or partially closing the two sever shaped apertures.

Preferably one or other or both of the disc members or apertures on the sealing face(s) has a central groove or blind aperture therein.

Preferably the stator disc has a central groove extending traversely of disc between the two sector shaped apertures.

### BRIEF DESCRIPTION OF THE DRAWINGS

These and other aspects of this invention, which will be considered in all its novel aspects, will become apparent from the following description, which is given by way of example only, with reference to the accompanying drawings, in which:

FIG. 1 is a schematic view of the valve and its components.

FIG. 2 is a three-quarter perspective view of the valve body with the cover removed to show the upper disc.

FIG. 3 is a top perspective view of the valve body of FIG. 2.

FIG. 4 is an assembled view.

FIG. 5 is a cross section view of FIG. 4.

FIG. 6 is a logic diagram showing the process control steps.

FIG. 7 illustrates an encoder disc.

FIG. 8 is an exploded view of the encoder.

FIG. 9 illustrates a modified stator disc with groove.

FIG. 10 is an exploded view of part of the valve showing the stator disc the moveable disc, and the spindle.

FIG. 11 Shows a top perspective view of the moveable disc.

FIGS. 12-15 Shows different views of the valve with dimensions A to F which match the dimensions of the valves detailed in Table 1.

### EXAMPLE 1

In its most preferred form the valve of this invention has the following components:
A valve body 10 having an inlet 11 and an outlet 12.
A pair of shear action discs 13, 14 situated within the valve body, with one disc 14 rotatable relative to the other disc 13. Each disc having at least one aperture.
A stepper motor 20 mounted on the valve body, having a shaft connected to one of the discs, and capable of the controlled rotation of one of the discs relative to the stationary disc.
A pair of pressure sensors 30, 31 mounted in the valve body, one associated with the inlet port, and one associated with the outlet port.
A microprocessor controller 40 mounted on the valve (preferably forming part of the housing containing the stepper motor).
A pair of sensor cables 50, 51 capable of supplying a signal from each of the pressure sensors to the microprocessor controller.

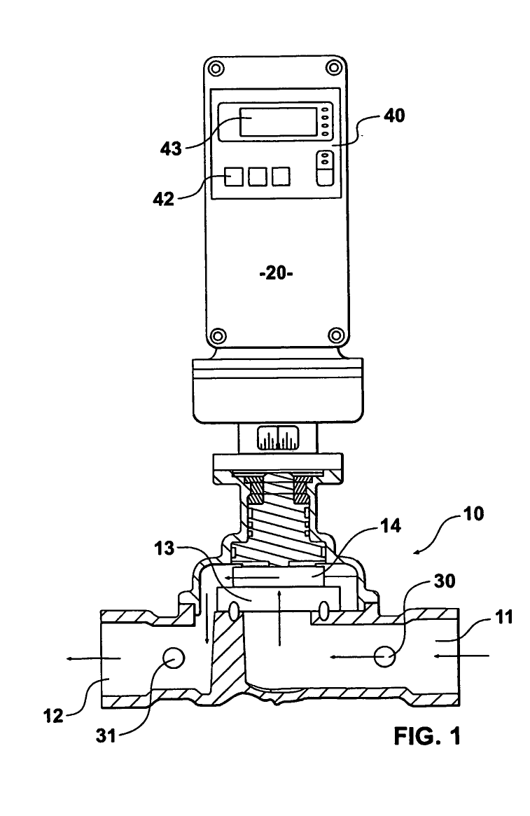

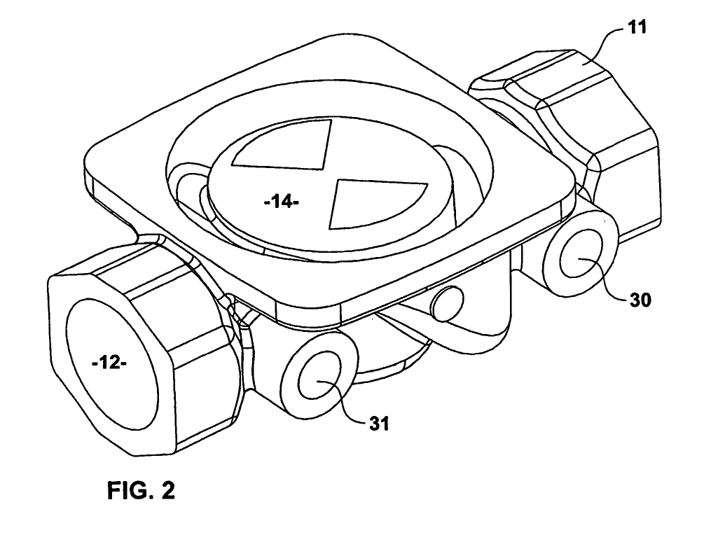

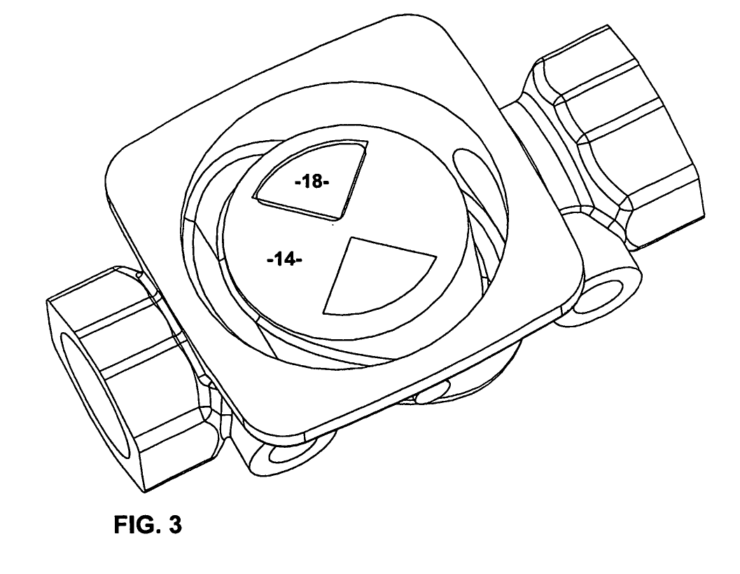

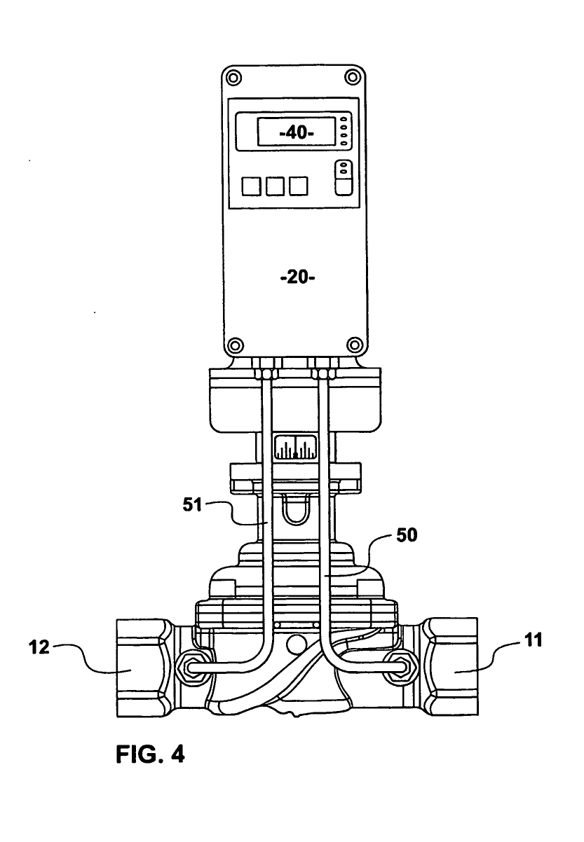

These components are shown in the assembled view of FIG. 4. With the valve closed it is not possible to see the position of the discs. These discs are apparent from the schematic view of FIG. 1, and the top perspective views of FIGS. 2 and 3 (where the top of the valve has been removed to show the position of the upper disc).

The inlet and outlet ports are adapted to be connected to a pipeline, and will be provided with appropriate fittings, depending upon the size of pipe or pipeline to which they are to be attached. Typically they will be attached by screw-thread fittings, of the type used in a particular process.

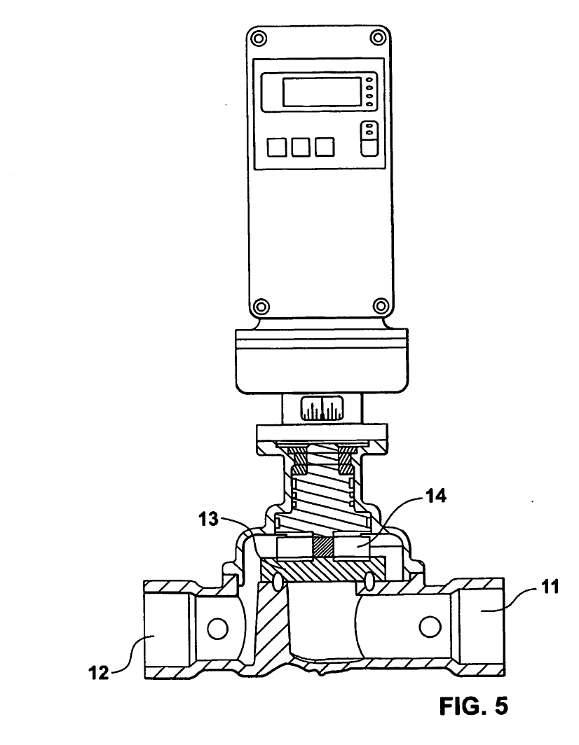

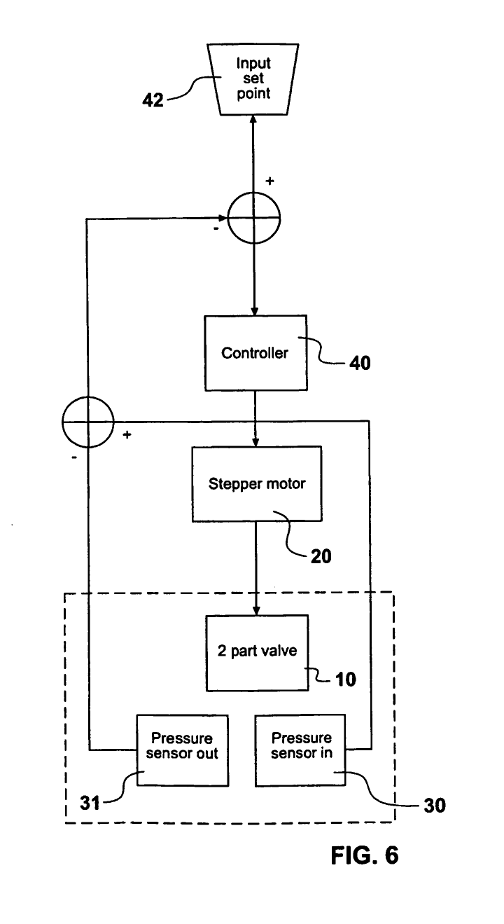

As shown in FIGS. 1 and 5 liquid will flow into the inlet, through the apertures in the pair of discs when they are fully or partially aligned to allow liquid to flow through, and out through the exit port.

Preferably the lower most disc of FIG. 1 is attached to a valve body, and preferably this disc is a ceramic disc having one or more apertures there through. The stationary disc can be integral with the main valve body, as its purpose is simply to provide a substantially flat planar surface on which the upper disc rotates.

Preferably the lower most disc and the upper most disc have two sector shaped apertures 18 in each disc, with the sectors facing one another as shown in FIGS. 2 and 3. Alternatively, the upper disc 14 may have two sector shaped lobes (as shown in FIG. 11) so that sides function as unbounded sector shaped apertures. The area of these apertures relative to the area of the disc can be designed during manufacture to accommodate a variety of characteristics depending upon the required flow rate or capacity of the valve. It is preferred that the apertures, and the shape of the valve body are designed to allow for non-turbulent flow through the valve, or at least non-turbulent flow in the areas associated with the pressure sensors, as will be explained below.

The mating surfaces of the two discs are preferably low friction ceramic surfaces so that the upper disc can rotate freely with respect to the lower stationary disc. As will be apparent from FIGS. 2 and 3 if the upper disc is rotated from its fully open position through 90 degrees then the valve will be filly closed, as the sector shaped apertures of the upper disc will no longer be in alignment with the corresponding sector shaped apertures of the lower disc. This assumes that the apertures in the upper and lower discs are the same shape and size, but it will be appreciated that it is possible to make the apertures in the lower disc of a different size or shape from that in the upper disc depending upon the flow parameters required for the valve.

The upper disc 14 is connected via an appropriate spindle to a stepper motor 20, which is mounted on the exterior of the valve body.

Mounted above the stepper motor is the microprocessor control unit 40, which accepts input from the pair of pressure sensors 30, 31, and provides an appropriate output to the stepper motor. The control unit can include a number of manual input device 42, as well as a visual display 43 (preferably an LCD screen) so that an operator can set the process parameters required, for example a specified pressure or flow rate, and check the setting on the display screen. Preferably the unit also has the ability to display fluctuations in the sensory inputs, for example by displaying in different modes the dynamic pressure, the static pressure, and/or the instantaneous flow rate.

The control unit preferably has a data output capable of connecting to a data bus of a main system computer, or an output to a data logger such as a printer, or other recorder.

Preferably a pair of pressure sensors are mounted on the valve body as shown. A preferred pressure sensor is a 0-20 bar pressure sensor supplied by Kistler, part number FER18, details available via www.kistler.com. Such a sensor is a piezoelectric pressure transducer capable of measuring dynamic pressure. The locations of these sensors are preferably adjacent the inlet and outlet ports in positions where the sensors provide the best measurement of dynamic pressure, i.e. the locations will depend upon the design of the valve chamber and its flow characteristics. A non-turbulent flow position for the sensors within the valve body is preferred.

### EXAMPLE 2

### Pressure Measurement

If the valve is to measure pressure within the valve body as liquid flows therethrough, the pressure sensor can monitor the dynamic pressure within the valve body, and this information can be converted by appropriate algorithm to the static pressure depending upon various parameters of the valve. Since the pressure sensor will be pre-installed in a specially designed valve body, the characteristics of the valve, and hence the control unit can monitor the static pressure.

### EXAMPLE 3

### Flow Rate

If flow rate is to be measured by the control unit and/or the flow rate through the valve determined by adjusting the shear action discs within the valve body then two pressure sensors are preferably used, to monitor the pressure at the input and the output, and the pressure measurements are converted through an appropriate algorithm to a measure of the flow rate. This can be based on Bernoulli's theorem, which defines the relationship between pressure and flow rate within a moving fluid.

### EXAMPLE 4

### Encoder

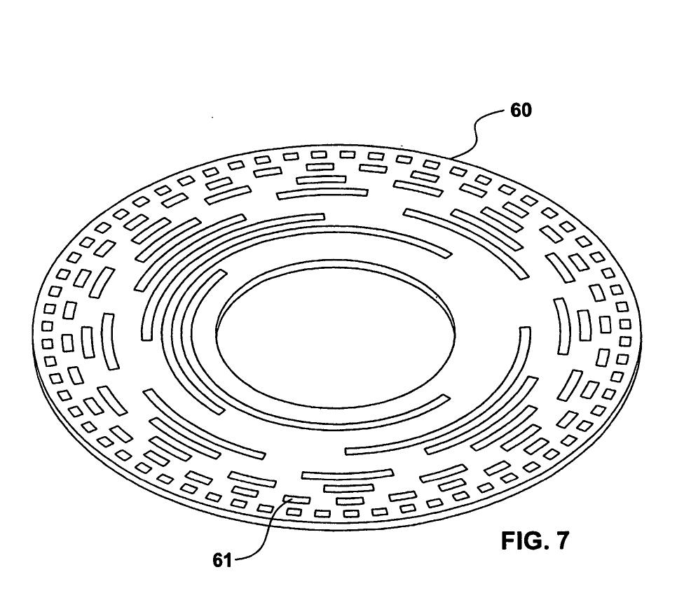

In this example it is preferred that the stepper-motor is connected to a gearbox which is connected to an encoder disc 60, on the suspension shaft, which encoder provides absolute position information to the microprocessor and hence to the stepper-motor. Such an encoder disc 60 is shown in FIG. 7, and has an etched or printed pattern 61 on the disc, enabling an appropriate optical transmitter and receiver to operate in conjunction with the movement of the encoder disc to precisely determine the position of the encoder disc, and hence the position of the moveable valve disc, and in consequence the position of the stepper-motor. The geared stepper-motor itself may be designed to move in increments of 0.024° at the output shaft (after the gearbox) whilst the encoder disc may be designed to any required degree of accuracy, consistent with the cost of the device and the capability of the stepper-motor.

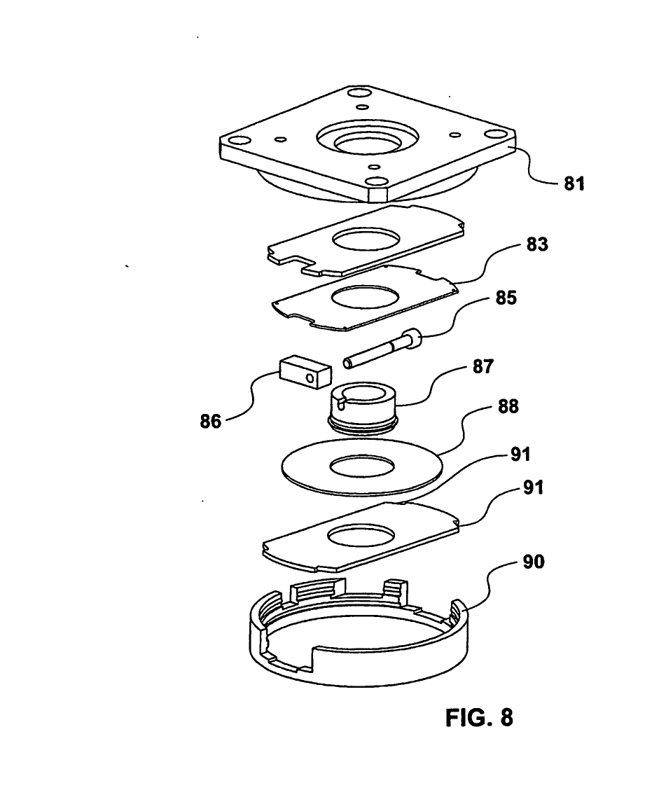

The encoder disc and its components are shown in FIG. 8 as an exploded view, the encoder unit has the following components: a mounting plate gearbox 81, an encoder PCB transmitter 82, an encoder PCB mask 83, an encoder screw adjustment 85, a dog encoder adjuster 86, a bush encoder 87, the encoder disc 88, an encoder mounting ring 90 and an encoder PCB receiver 91. It should be noted that some of these features (such as the encoder disc 80) are shown without surface detail in this figure.

The encoder unit is preferably mounted between the stepper-motor, and the top of the valve body, so that the encoder disc is moved in unison with the drive shaft of the stepper-motor, and in turn is moved in unison with the movement of the moveable valve disc. This can be seen in some detail in the exploded view of the valve body and its components shown in FIG. 10.

The advantage of the absolute encoder in conjunction with the stepper-motor, is that the encoder can provide an absolute rotational position of the movable valve disc relative to the stator disc, even if the stepper-motor slips during action, or if the power is turned off and the stepper motor losses its relative rotational position (stored in its memory as the number of steps taken to move in a particular circumferential direction, which can be lost when powered to the device is lost). When power is restored, the microprocessor can interrogate the encoder and determine the position of the encoder disc, and hence the position of the moveable valve disc. The microprocessor can then feed information back to the stepper-motor to move the stepper-motor the required number of degrees, and this can be crossed checked against the position of the encoder.

### EXAMPLE 5

### Grooved Disc

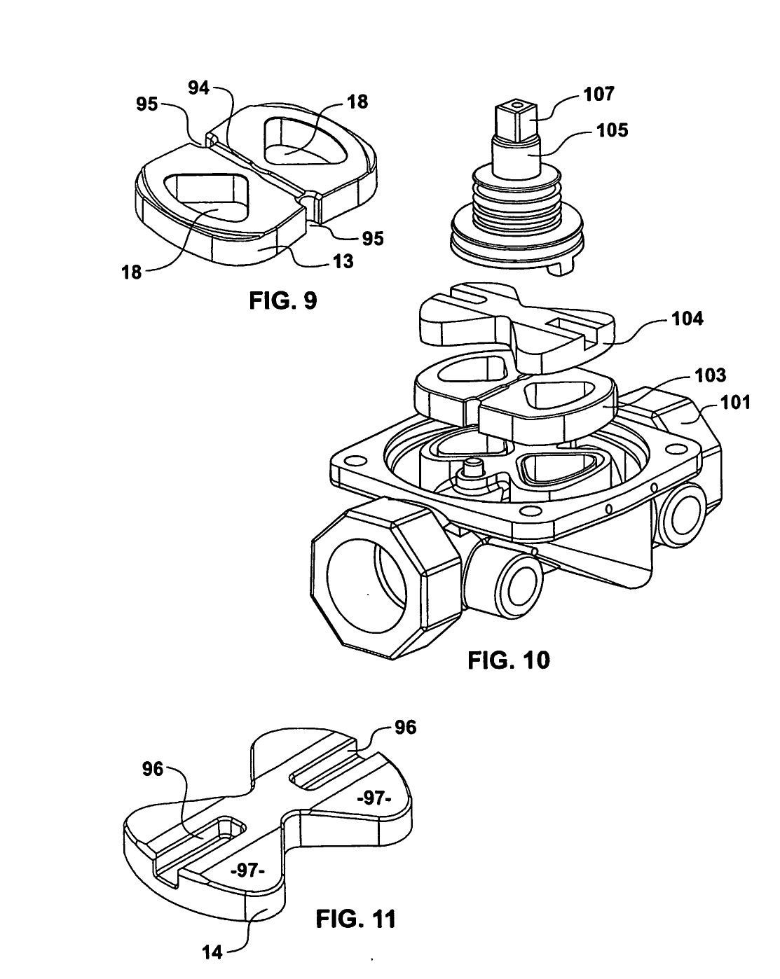

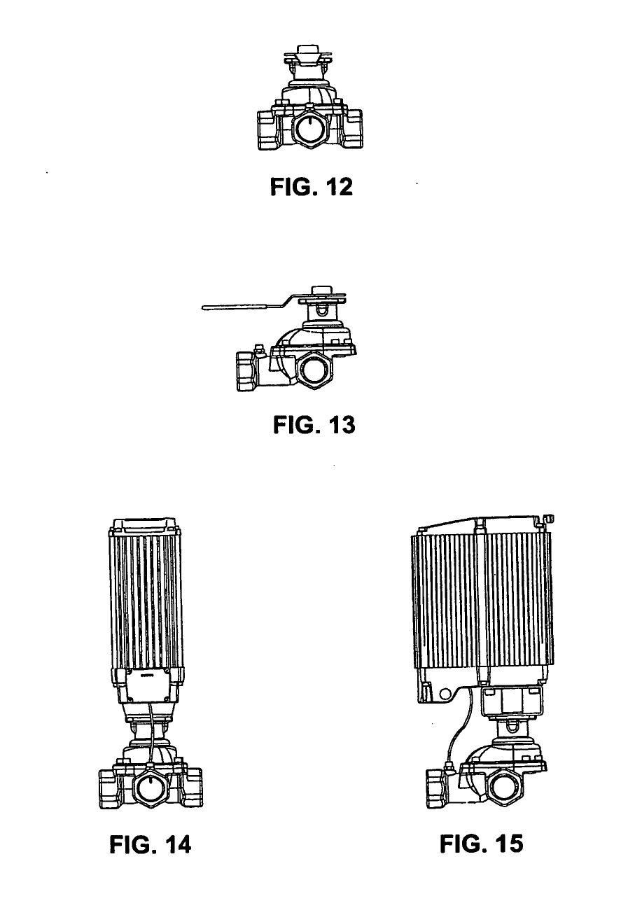

In this example the valve can be similar to that of example 1 or example 5, with the addition of a groove 94 or blind aperture in the stator disc 13. This groove is preferably as shown in FIG. 9, and preferably extends across the width of the stator disc, passing through the centre of the stator disc. In an alternative (not shown) instead of a groove there may be a depression or aperture at the centre point. However a groove is preferred. The purpose of this groove which is preferably about 0.6 mm deep on a stator disc which might be 8 mm thick and have a length of 55 mm and a width of 38 mm (these dimensions are being given purely by way of example), the groove assisting in removing any grit, or an abrasive materials which might pass through the valve and be trapped in the centre of the stator disc. (The dead centre of the stator disc is not wiped by movement of the rotor disc, so the presence of a blind aperture or groove on the sealing face of either disc eliminates this “dead point”). We have found that flow through the two port valve of this invention can result in excessive wear of the rotatable discs, if a central aperture, or central groove is not provided on either the stator disc or the rotor disc. We prefer to provide this on the stator disc, and to allow for flow to occur across the central portion of the stator disc, to remove any grit or other residue that might otherwise be introduced into the valve.

In FIGS. 9 and 10 the stator disc is shown as an oblong shape, having apertures or notches 95 at either side of the traverse centre groove 94 of FIG. 9. These apertures provide anchor points for the stator disc 13, to assist in locating the stator disc 13 and preventing rotation of the stator disc, whilst the rotor disc 14 moves relative to the stator disc 13. In FIG. 11 the rotor disc 14 is shown as a substantially “figure 8” shape, with a pair of blind apertures 96 on the upper surface thereof, capable of co-operating with the fingers of the drive shaft, so that the rotation of the drive shaft will cause rotation of the rotor disc 14 about the centre point of the stator disc 13.

The shape and surface of the two lobes 97 of the rotor disc is such that they are preferably larger than the substantially sector shaped apertures 18 of the stator disc 13. Movement of the rotor disc 14 relative to the stator disc 13 will cause the apertures of the stator disc 13 to be fully closed when the rotor disc 14 is in the north-south position relative to the stator disc, but will cause the apertures to be progressively opened as the rotor disc 14 moves from the north-south position towards the east-west position.

FIG. 10 is an exploded view of the valve and has the following components:

| | |
|---|---|
| 101 | Body |
| 103 | Disc Fixed |
| 104 | Disc Moving |
| 105 | Spindle |
| 107 | Nut Top |

In normal use the rotor disc 14 will move incrementally clockwise and anticlockwise respectively to move into the open position and then back towards the closed position to control the pressure or flow rate in the pipeline.

### EXAMPLE 6

In some cases an external temperature sensor can be connected to the microprocessor. Such a configuration is useful for the dairy industry where pasteurisation at 74.5° C. may be seriously affected by pressure fluctuations in the heat exchanger.

### ADVANTAGES OF THE PREFERRED EMBODIMENT

By providing the valve as a pre-assembled “plug and play” component, the valve can easily be installed into a pipeline by a relatively unskilled worker. All the intelligence in the unit is contained within the controller which is mounted on the exterior of the valve body, the sensors are already connected to the controller so that once the valve is connected to the pipeline, and fluid is allowed to flow, the controller can immediately monitor pressure or flow in the valve, and hence control the pressure and or flow rate of the fluid. This gives a tighter faster control loop.

By using a stepper motor, the stepper motor can move the rotatable disc in precise increments, with the ability to know the location of the stepper motor, and hence the disc relative to the stationary disc. This ability is enhanced by the inclusion of the encoder of example 4. Because the valve incorporates a closed loop control, the output from the pressure sensors can be used to control the position of the valve discs, and hence the pressure or flow rate within the valve.

The two port valve of this invention utilises ceramic shear action disc technology to provide tight shut-off, high-pressure differential capability and long life integrity. The valve has a built in electronic actuator using a stepper-motor, which together with its built in microprocessor, and sensor inputs, allows high speed stand alone close loop control. This allows for ease of installation in a pipeline, and with its additional outputs it can be connected to a database to a central processor, controlling the operation of different perimeters of the plant.

This allows the valves of this invention to be precisely and easily and quickly controlled. They allow far greater precision and accuracy of flow control compared with butterfly or globe valves.

In the preferred embodiments the design of the two port valve makes use of ceramic shear action discs as the dynamic seal. The extremely hard nature of these ceramic discs produces outstanding resistance to wear and cavitation damage compared with conventional elastomer and plastic seated valves, thereby minimising seal replacement and plant downtime. In example 5, the valve has the added feature of the central groove in the stator disc which provides for additional wear resistance, by providing a channel by which any introduced grit or other abrasive material can be swept clear of the mating surfaces of the valve. These valves are suitable for mixing of hot silica rich water which often destroys the seals of existing valves.

The valves of the preferred embodiments include the following features:
ISO 5211, 5210 actuator flange mountings,
It can be constructed of any suitable material, although we prefer 316 stainless steel or brass,
Ceramic discs which are durable, and corrosion resistant, and especially suitable for process control,
Elastomer seal options, and
Top entry (removable bonnet) allows inline access to internal valve parts.

The valves of this invention are liquid, gas, and steam capable. The pressure transducers can be fitted through the half-inch sensor ports shown in the drawings, which enable the pressure transducers to be inserted into the non-turbulent flow portions of both the inlet and the outlet. The stepper-motor is connected to rototable disc by means of planetary gearbox. A position indicator is provided by a visual indication on the shaft, and by a display connected to the non-contact absolute encoder. The valve is specially provided with a 3.5 digit LCD display with back light, so that the operating parameters can be viewed on the valve itself if inspection is required.

Another advantage of this valve is the ease of opening under pressure and the ability to minimise the effect of “water hammer” on closing (which is a significant problem with butterfly valves installed in a high pressure line).

### Valve Specifications

The following specifications are illustrative only, of a number of prototype valves, and are provided to assist in understanding the characteristics and performance of this type of valve. The specifications illustrated in this table are the specifications for water passing through the valve. The minimum temperature figure shown may be quite a special accessories, e.g. spindle extension heater. The flow rates are quoted without terminal fittings or restrictor/check valves on inlets.

Dimensions A, B, C, and E for a range of valves are detailed in Table 1, and these dimensions are labelled FIGS. 12 and 13. Dimension D is show in FIG. 15.

Table 2 shows the pressure and temperature characteristics of their range of valves, as well as the actuator mounting details.

TABLE 1

| | NOMINAL VALVE SIZE | | | | |
|---|---|---|---|---|---|
| | mm | 20 | 25 | 40 | 50 |
| | A | 120 | 120 | 172 | 220 |
| | B | 103 | 111 | 146 | 165 |
| | C | 138 | 163 | 199 | 270 |
| | D | 389 | 396 | 426 | 484 |
| | E | 145 | 145 | 200 | 200 |
| Operating Stroke | ° rotational | 230 | 230 | 230 | 230 |
| Thread Size: Inlet | BSP or NPT | 0.75″ | 1″ | 1.5″ | 2″ |
| Thread Size: Outlet | BSP or NPT | 1″ | 1.25″ | 1.5″ | 2.5″ |
| Flow Characteristics | | | | | |
| 2 Port Open (160° open) | | | | | |
| Kvs m3/h at dP = 1 bar, | | 7.0 | 10.9 | 17 | 41.3 |
| ˜20° C. | | | | | |
| Flow @ 4 bar dP | m3/h | 14.1 | 21.7 | 34 | 82.7 |
| Flow @ 4 bar dP | 1 pm | 234 | 362 | 566 | 1378 |
| 1 Port Open (90° open) | | | | | |
| Kvs m3/h at dP = 1 bar, | | 5.5 | 8.7 | 12.6 | 35 |
| ˜20° C. | | | | | |
| Flow @ 4 bar dP | m3/h | 10.9 | 17.3 | 25.3 | 69.5 |
| Flow @ 4 bar dP | 1 pm | 182 | 288 | 422 | 1158 |
| Leakage Characteristics | | | | | |
| (% Kvs) | | | | | |
| Port A to B, B to A | % | 0 | 0 | 0 | 0 |
| Port A or B to C | % | 0 | 0 | 0 | 0 |
| Separate isolation required | | no | no | no | no |

TABLE 2

| | NOMINAL VALVE SIZE | | | | |
|---|---|---|---|---|---|
| | Mm | 20 | 25 | 40 | 50 |
| Pressure Characteristics | | | | | |
| Max dPv100* | Bar | 9 | 9 | 9 | 9 |
| dP max (closed) | Bar | 20 | 20 | 20 | 20 |
| Operating press. | Max | 20 | 20 | 20 | 20 |
| | bar g | | | | |
| Fluid Temperature | | | | | |
| Characteristics | | | | | |
| Max Temperature** | ° C. | 90 | 90 | 90 | 90 |
| Min. Temperature | ° C. | −30 | −30 | −30 | −30 |
| Position resolution with | +/− | 0.006 | 0.006 | 0.006 | 0.006 |
| Emech (° rotational) | | | | | |
| Accessories | Extended actuator brackets: spindle heater | | | | |
| Actuator Mounting | Spigot/bolt as per ISO 5210/ISO 5211 | | | | |
| Shaft/stem connection | mm (sq. | 10 | 10 | 14 | 14 |
| | std) | | | | |
| Topworks PCD | mm | 50 | 50 | 70 | 70 |
| Topworks PCD hole | mm | 6.5 | 6.5 | 8.5 | 8.5 |
| diameter | | | | | |
| Topworks, Spigot | mm | 35.1 | 35.1 | 55.1 | 55.1 |
| diameter | | | | | |
| Valve mounting | | None | none | none | none |
| restrictions | | | | | |

*Maximum allowable pressure drop at full flow
**These maximum temperature are shown for water. Provision can be made for the steam and water mixing applications.

### VARIATIONS

The valve of the preferred embodiments shows an inlet port and an outlet port, and a pair of rotational sheer action discs having a pair of sector shaped apertures. It will be appreciated that the valve could for example include more than one input or more than one output and that the rotational disc valve could have one or more apertures of varying shapes or sizes.

Although it is preferred that the stator disc has at least one sector shaped aperture bounded by the material of the stator disc, this need not be the case with the rotational disc. The rotational disc can have one or more apertures or “cut-outs” which are only partially bounded by the exterior edges of the disc. As shown in FIG. 11 this results in a “wasted” or “figure 8” shaped moveable member having two substantially sector shaped lobes. The rotor and stator disc shapes could be interchanged. The blind aperture or groove on the stator disc could be on the rotor disc (or on both discs).

The stepper motor could be replaced by other actuators, for example an electric motor (particularly a DC motor) and gear box together with position sensors, however we prefer a stepper motor because of the advantages in terms of accuracy in movement, and its inherent ability to provide positional information. Absolute position sensors other than encoder discs could be used in conjunction with the stepper motor.

The shape or materials of the valve body could be changed, and any type of microprocessor controller could be used with one or more data outputs. For example, steel discs can be used in place of ceramic discs where the valve is required to deal with higher pressures.

Finally, various other alterations or modifications may be made to the foregoing without departing from the scope of this invention.

1. A process control valve for installation in a pipeline, the valve having a valve body, the body having at least one fluid inlet port and at least one fluid outlet port; a first disc member capable of defining at least one inlet aperture communicating with said at least one inlet port; and a second disc member capable of defining at least one outlet aperture communicating with said at least one outlet port; the first and second disc members are arranged in sealing contact and are rotatable relative to one another; an electric motor capable of rotating at least one of the discs relative to the other disc; means for determining the relative rotational position of the discs; at least one sensor mounted within the valve body to monitor a desired parameter within the valve body; a microprocessor controller capable of controlling the operation of the motor and hence the relative position of the discs; and wherein the at least one sensor is connected to the microprocessor controller, the at least one inlet aperture is substantially sector shaped and the at least one outlet aperture is substantially sector shaped so that relative rotation of the discs by the electric motor provides control over the desired parameter within the pipeline, and also allows for the fluid flow to be completely impeded when the apertures are not aligned with one another.

2. A process control valve as claimed in claim 1, wherein the sensor is a pressure sensor or a flow rate sensor so that the microprocessor electric motor can provide control over the fluid flow or pressure within the pipeline.

3. A process control valve as claimed in claim 1, wherein the motor is a stepper motor.

4. A process control valve as claimed in claim 3, wherein the valve body has a first pressure sensor mounted in the fluid inlet port, and a second pressure sensor mounted in the fluid outlet port.

5. A process control valve as claimed in claim 4, wherein the means for determining the relative rotational position of the discs includes an encoder having an output connected to the microprocessor controller.

6. A process control valve as claimed in claim 5, wherein the microprocessor controller is connected to a user controlled input capable of selecting a chosen output parameter.

7. A process control valve as claimed in claim 6, wherein the valve body has one fluid inlet port and one fluid outlet port; and the first disc member has two sector-shaped inlet apertures; and a second disc member having two sector-shaped lobes capable of fully or partially closing the two sector shaped apertures.

8. A process control valve as claimed in claim 7, wherein one or other or both of the disc members has a central groove or blind aperture on the sealing face(s) thereof.

9. A process control valve as claimed in claim 8, wherein the stator disc has a central groove extending traversely of the disc between the two sector shaped apertures.

10. A process control valve as claimed in claim 1, wherein the disc members are ceramic discs.
